(19) United States
(12) Patent Application Publication
(10) Pub. No.: US 2024/0142950 A1
(43) Pub. Date: May 2, 2024

(54) AUTOMATED PERFORMANCE INDICATOR EVALUATION

(71) Applicant: SAUDI ARABIAN OIL COMPANY, Dhahran (SA)

(72) Inventor: Ibrahim N. Almohaimeed, Khursaniyah (SA)

(73) Assignee: SAUDI ARABIAN OIL COMPANY, Dhahran (SA)

(21) Appl. No.: 18/050,318

(22) Filed: Oct. 27, 2022

(51) Int. Cl. G05B 19/418; G06Q 10/06

(52) U.S. Cl. CPC G05B 19/4183; G06Q 10/06393; G05B 2219/23123

(57) ABSTRACT

The present disclosure relates to systems and/or methods for automatically collecting and evaluating PI data from one or more controllers of a production facility. For example, various embodiments described herein can relate to a method for evaluating the performance of a production facility that includes establishing an authenticated connection with a performance indicator server in accordance with a defined schedule. The performance indicator server stores data from one or more controllers that manage assets of a production facility. The method can include automatically evaluating a performance of the production facility, via a performance evaluation algorithm, in response to collecting performance indicator data via the authenticated connection.

### FIELD OF THE DISCLOSURE

The present disclosure relates generally to systems and methods for automatically evaluating performance indicators of one or more controllers and, more particularly, to automatically collecting and analyzing performance indicator data regarding one or more controllers operating in a facility.

### BACKGROUND OF THE DISCLOSURE

Performance indicators (“PIs”) are objective-oriented metrics for evaluating the performance of equipment, systems, and/or methods. PIs can be a direct reflection of a performance objective, or can be a subset of several objectives. Where controllers are used to manage one or more assets of a production facility, PIs can be measured by the controllers to evaluate the performance of the assets (e.g., equipment) and/or improve the efficiency of the production facility operations with respect to one or more target objectives. For instance, the controllers can be adjusted, tuned, and/or optimized based on recorded PIs.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method is provided. The method can comprise establishing an authenticated connection with a performance indicator server in accordance with a defined schedule, wherein the performance indicator server stores data from one or more controllers that manage assets of a production facility. The method can further comprise automatically evaluating a performance of the production facility, via a performance evaluation algorithm, in response to collecting performance indicator data via the authenticated connection.

In another embodiment, a system is provided. The system can comprise memory to store computer executable instructions. The system can also comprise one or more processors, operatively coupled to the memory, that execute the computer executable instructions to implement a data collector configured to establish an authenticated connection with a performance indicator server in accordance with a defined schedule. The performance indicator server can store data from one or more controllers that manage assets of a production facility. The one or more processors can also execute the computer executable instructions to implement a data analyzer configured to automatically evaluate a performance of the production facility, via a performance evaluation algorithm, in response to collecting performance indicator data via the authenticated connection.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a diagram of a non-limiting example system that can automatically generate and/or publish performance summary reports regarding PI data that characterizes operations at one or more production facilities in accordance with one or more embodiments described herein.

FIG. 2 is a diagram of a non-limiting example system that can comprise one or more performance evaluators for analyzing one or more PIs characterizing operations by one or more controllers in accordance with one or more embodiments described herein.

FIG. 3 is a flow diagram of a non-limiting example method that can be implemented by one or more systems to automatically analyze PI data and publish one or more performance summary reports in accordance with one or more embodiments described herein.

FIG. 4 illustrates a block diagram of non-limiting example computer environment that can be implemented within one or more systems described herein.

### DETAILED DESCRIPTION

Embodiments of the present disclosure will now be described in detail with reference to the accompanying figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to automatically collecting and analyzing PI data to evaluate the performance of one or more production facilities. Various embodiments described herein can pertain to computer methods and/or systems that can automatically authenticate and connect to one or more PI servers in accordance with one or more predefined schedules. Thereby, the computer methods and/or systems can collect PI data provided by one or more controllers configured to manage and/or observe various performance features of the production facilities. For example, the one or more schedules can define the frequency of PI data retrieval operations, timeframes targeted by the PI data retrieval operations, and/or controllers of interest. Additionally, upon receiving the PI data, a performance evaluator can automatically analyze the PI data in relation to one or more predefined thresholds to generate one or more performance summary reports that can be shared with one or more supervisor entities, which can utilize the performance evaluation characterized by the reports to adjust and/or optimize future operations of the one or more controllers.

Moreover, various embodiments described herein can constitute one or more technical improvements over conventional performance evaluation techniques by automating PI data collection and analysis in accordance with a defined schedule. For instance, various embodiments described herein can automatically authenticate and connect to one or more PI servers on a periodic basis to collect PI data that characterizes the performance of one or more plant assets managed by one or more controllers. Further, various embodiments described herein can automatically compare the collected PI data to defined thresholds that characterize a desired performance. Thereby, the embodiments described herein can enable a consistent, efficient, and regular performance analysis that can be scaled to include multiple controllers and a vast amount of PI data. Additionally, one or more embodiments described herein can have a practical application by automatically generating performance summary reports for review by one or more supervisor entities on a routine basis. For example, one or more embodiments described herein can generate reports summarizing the automated analysis of the PI data, and the reports can be distributed amongst one or more supervisor entities associated with the controllers of the one or more production facilities. Based on the performance summary reports, the one or more supervisor entities can subsequently adjust and/or optimize one or more settings of the controllers to improve performance (e.g. efficiency) of the production facilities.

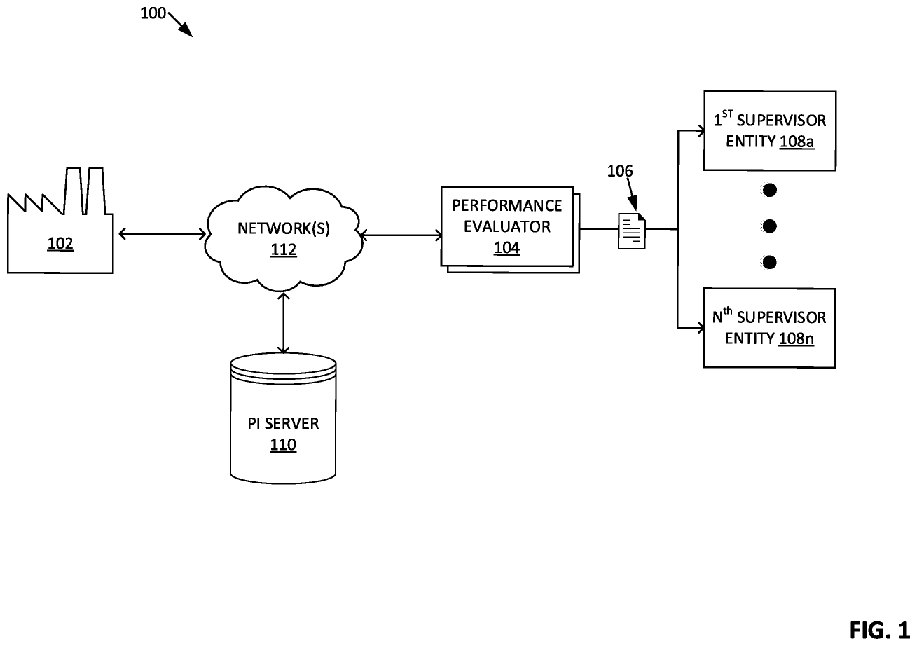

FIG. 1 illustrates a non-limiting example system 100 that can automatically analyze the operations of one or more production facilities 102 in accordance with one or more embodiments described herein. As shown in FIG. 1, the system 100 can comprise one or more performance evaluators 104, which can generate one or more performance summary reports 106 characterizing operations at the one or more production facilities 102. Further, the one or more performance evaluators 104 can share the one or more performance summary reports 106 with one or more supervisor entities 108, which can adjust one or more features of the production facilities 102 based on the performance summary reports 106 to improve efficiency of the operations.

In various embodiments, the one or more production facilities 102 can include, but are not limited to: factories, production plants, manufacturing plants, oil and gas facilities (e.g., well sites, produced water injection facilities, natural gas gathering compressor stations, natural gas treatment stations, natural gas extraction and/or fractionation plants, natural gas transmission compressor stations, natural gas underground storage facilities, oil pipeline breakout facilities, oil tank farms, oil refineries, refined petroleum pipeline pump stations, refined petroleum product terminals, and/or the like), material processing facilities, data processing facilities, refineries, a combination thereof, and/or the like. Additionally, the one or more production facilities 102 can comprise various equipment (not shown) to perform its designated function.

In one or more embodiments, the one or more production facilities 102 can share PI data with one or more PI servers 110 via one or more networks 112. For example, the one or more networks 112 can comprise one or more wired and/or wireless networks, including, but not limited to: a cellular network, a wide area network (“WAN”), a local area network (“LAN”), a combination thereof, and/or the like. One or more wireless technologies that can be comprised within the one or more networks 112 can include, but are not limited to: wireless fidelity (“Wi-Fi”), a WiMAX network, a wireless LAN (“WLAN”) network, BLUETOOTH® technology, a combination thereof, and/or the like. For instance, the one or more networks 112 can include the Internet and/or the IoT. In various embodiments, the one or more networks 112 can comprise one or more transmission lines (e.g., copper, optical, or wireless transmission lines), routers, gateway computers, and/or servers. Further, the one or more production facilities 102 and/or PI servers 110 can comprise one or more network adapters and/or interfaces (not shown) to facilitate communications via the one or more networks 112.

The PI data can include one or more measurements characterizing operation of the one or more production facilities 102. For instance, the PI data can include measured values for one or more metrics related to a targeted objective of the production facility 102 operations. For example, the PI data can characterize the status of equipment within the one or more production facilities 102. In another example, the PI data can delineate one or more characteristics of inputs to the one or more production facilities 102. In a further example, the PI data can delineate one or more characteristics of outputs from the one or more production facilities 102. In a still further example, the PI data can characterize resources consumed during operation of the one or more production facilities 102. In one or more embodiments, the PI data can be captured by one or more sensors, meters, supervisory control and data acquisition (“SCADA”) devices, distributed control system (“DCS”) devices, and/or the like. Example measurements that can be included in the PI data can include, but are not limited to: pressure measurements, temperature measurements, velocity measurements, energy consumption measurements, material composition analyses, purity analyses, vibration monitoring measurements, flow rate, volume, geographical locations, material source identification, material destination identification, a combination thereof, and/or the like.

In various embodiments, the one or more production facilities 102 can share the PI data with the one or more PI servers 110 continuously, or near continuously, in real-time, or near real-time. Alternatively, the one or more production facilities 102 can share the PI data with the one or more PI servers 110 in accordance with one or more schedules.

In one or more embodiments, the one or more PI servers 110 can store the PI data. Additionally, the one or more PI servers 110 can process the PI data by executing one or more data processing techniques, including but not limited to: data aggregation, data sampling, data rescaling, data binarization, data augmentation, a combination thereof, and/or the like. For example, the PI servers 110 can categorize and/or organize the PI data (e.g., based on the data source, time, geography, types of measurements included in the data, a combination thereof, and/or the like). Additionally, the PI servers 110 can add metadata to the PI data (e.g., label the PI data). For instance, in one or more embodiments, the PI servers 110 can timestamp the PI data. In another instance, the PI data can be timestamped when collected by the production facility 102 and organized (e.g., chronologically) by the one or more PI servers 110.

In various embodiments, the one or more performance evaluators 104 (e.g., a server, a desktop computer, a laptop, a hand-held computer, a programmable apparatus, a minicomputer, a mainframe computer, an Internet of things (“IoT”) device, or a software program executing on any such devices, and/or the like) can be operably coupled to (e.g., communicate with) the one or more production facilities 102 and/or PI servers 110 via the one or more networks 112.

In one or more embodiments, the one or more performance evaluators 104 can automatically retrieve PI data from the one or more production facilities 102 and/or PI servers 110 in accordance with a defined schedule. For example, the one or more performance evaluators 104 can perform PI data retrieval at defined times, days, and/or time period intervals (e.g., twenty-four hour intervals). Additionally, the one or more performance evaluators 104 can retrieve PI data related to a defined timeframe (e.g., a duration), in accordance with the defined schedule. For instance, where the defined timeframe is the last twenty-four hours, the one or more performance evaluators 104 can retrieve PI data collected and/or measured within the last twenty-four hours from the time at which the performance evaluator 104 is executing the PI data retrieval.

Additionally, the one or more performance evaluators 104 can automatically analyze the collected PI data to generate the one or more performance summary reports 106. For example, the one or more performance evaluators 104 can compare the collected PI data to one or more threshold values associated with the metrics characterized by the PI data (e.g., as further described below). In another example, the one or more performance evaluators 104 can identify metrics not included in the PI data (e.g., a missing metric can be indicative of a failed operation and/or a malfunctioning sensor). In various embodiments, the one or more performance summary reports 106 can summarize the data analysis performed by the performance evaluator 104 and can include, for example: text, charts, graphs, computer-readable elements, videos, a combination thereof, and/or the like.

Further, the one or more performance evaluators 104 can automatically share the one or more performance summary reports 106 with one or more supervisor entities 108. As shown in FIG. 1, the one or more performance evaluators 104 can share the one or more performance summary reports 106 with a plurality (“N”) of supervisor entities 108, such as: a first supervisor entity 108a and another supervisor entity 108n. For instance, the one or more performance evaluators 104 can automatically generate electronic correspondence (e.g., one or more emails), addressed to the supervisor entities 108, that includes the one or more performance summary reports 106. Based on the one or more performance summary reports 106, the one or more supervisor entities 108 can adjust, tune, and/or optimize one or more features and/or controls employed by the one or more production facilities 102 to improve efficiency and/or further promote an objective.

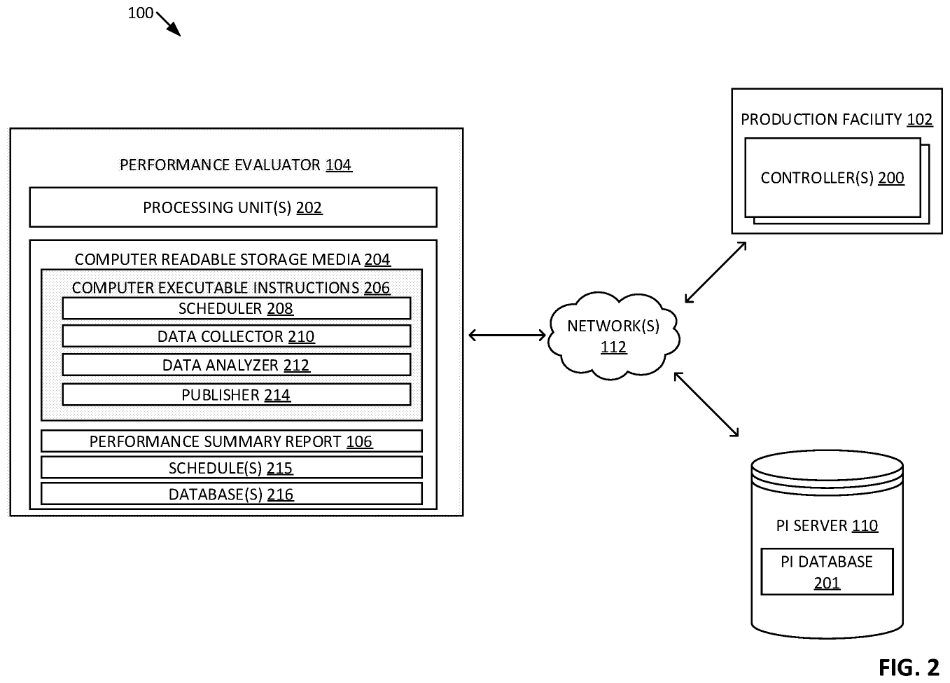

FIG. 2 illustrates a non-limiting example of the system 100 further comprising one or more controllers 200, PI databases 201, and/or various components of the performance evaluators 104 in accordance with one or more embodiments described herein. As shown, in FIG. 2, the one or more production facilities 102 can include one or more controllers 200. In various embodiments, the one or more controllers 200 can control and/or manage one or more assets of the production facilities 102, including, but not limited to: equipment of the production facilities 102 (e.g., manufacturing equipment), one or more sensors and/or sensor systems of the production facilities 102, data generated and/or employed by the production facilities 102, a combination thereof, and/or the like. For example, the one or more controllers 200 can be employed to manage operations of the one or more production facilities 102. For instance, the one or more controllers 200 can set control settings for one or more pieces of equipment in the production facilities 102. In another instance, the one or more controllers 200 can comprise, and/or be operably coupled to, one or more sensors and/or meters within the one or more production facilities 102; thereby, the one or more controllers 200 can measure, monitor, and/or observe the PI data.

In one or more embodiments, a production facility 102 can comprise a plurality of controllers 200, where each controller 200 can be associated with one or more respective performance metrics characterized by the PI data for the given production facility 102. Example types of controllers 200 can include, but are not limited to: open loop controllers, closed loop (feedback) controllers, proportional integral derivative (“PID”) controllers (e.g., in PID configuration, PI configuration, P configuration, and/or PD configuration), a combination thereof, and/or the like. In various embodiments, the one or more controllers 200 can measure, collect, and/or transmit the PI data to the one or more PI servers 110 and/or performance evaluators 104 (e.g., via the one or more networks 112).

As shown in FIG. 2, the one or more PI servers 110 can generate and/or maintain one or more PI databases 201 comprising the PI data received from the one or more production facilities 102. In accordance with various embodiments described herein, the one or more PI servers 110 can process the PI data via one or more data processing techniques to standardize, categorize, label, scale, and/or refine the PI data to generate the one or more PI databases 201. For example, the one or more PI databases 201 can sort the PI data chronologically, by metric, by source (e.g., according to a controller 200 and/or production facility 102 associated with the given PI data), a combination thereof, and/or the like. Additionally, the PI databases 201 can include the PI data in a standardized format, so that PI data can be subjected to a common search operation no matter its source.

In various embodiments, the one or more performance evaluators 104 can comprise one or more processing units 202 and/or computer readable storage media 204. In various embodiments, the computer readable storage media 204 can store one or more computer executable instructions 206 that can be executed by the one or more processing units 202 to perform one or more defined functions. In various embodiments, a scheduler 208, data collector 210, data analyzer 212, and/or publisher 214 can be computer executable instructions 206 and/or can be hardware components operably coupled to the one or more processing units 202. For instance, in some embodiments, the one or more processing units 202 can execute the scheduler 208, data collector 210, data analyzer 212, and/or publisher 214 to perform various functions described herein (e.g., automatically collecting PI data, generating performance summary reports 106, and/or sharing performance summary reports 106). Additionally, the computer readable storage media 204 can store the performance summary reports 106, one or more schedules 215, and/or one or more databases 216.

The one or more processing units 202 can comprise any commercially available processor. For example, the one or more processing units 202 can be a general purpose processor, an application-specific system processor (“ASSIP”), an application-specific instruction set processor (“ASIPs”), or a multiprocessor. For instance, the one or more processing units 202 can comprise a microcontroller, microprocessor, a central processing unit, and/or an embedded processor. In one or more embodiments, the one or more processing units 202 can include electronic circuitry, such as: programmable logic circuitry, field-programmable gate arrays (“FPGA”), programmable logic arrays (“PLA”), an integrated circuit (“IC”), and/or the like.

The one or more computer readable storage media 204 can include, but are not limited to: an electronic storage device, a magnetic storage device, an optical storage device, an electromagnetic storage device, a semiconductor storage device, a combination thereof, and/or the like. For example, the one or more computer readable storage media 204 can comprise: a portable computer diskette, a hard disk, a random access memory (“RAM”) unit, a read-only memory (“ROM”) unit, an erasable programmable read-only memory (“EPROM”) unit, a CD-ROM, a DVD, Blu-ray disc, a memory stick, a combination thereof, and/or the like. The computer readable storage media 204 can employ transitory or non-transitory signals. In one or more embodiments, the computer readable storage media 204 can be tangible and/or non-transitory. In various embodiments, the one or more computer readable storage media 204 can store the one or more computer executable instructions 206 and/or one or more other software applications, such as: a basic input/output system (“BIOS”), an operating system, program modules, executable packages of software, and/or the like.

The one or more computer executable instructions 206 can be program instructions for carrying out one or more operations described herein. For example, the one or more computer executable instructions 206 can be, but are not limited to: assembler instructions, instruction-set architecture (“ISA”) instructions, machine instructions, machine dependent instructions, microcode, firmware instructions, state-setting data, configuration data, source code, object code, a combination thereof, and/or the like. For instance, the one or more computer executable instructions 206 can be written in one or more procedural programming languages. Although FIG. 2 depicts the computer executable instructions 206 stored on computer readable storage media 204, the architecture of the system 100 is not so limited. For example, the one or more computer executable instructions 206 can be embedded in the one or more processing units 202.

In various embodiments, the scheduler 208 can generate one or more schedules 215 for PI data retrieval and/or analysis. For example, the one or more schedules 215 can define a frequency at which the one or more performance evaluators 104 can retrieve PI data for analysis. For instance, the one or more schedules 215 can define times, days, and/or time intervals at which the IP data is to be retrieved. In one or more embodiments, the one or more schedules 215 coordinate IP data retrieval at twenty-four intervals at a set time on selected days (e.g., business days or every day). Further, the one or more schedules 215 can delineate timeframes associated with the PI data to be retrieved at the designated time, date, and/or interval. For example, the one or more schedules 215 can set the timeframe based on an amount of minutes, hours, and/or days. In another example, the one or more schedules 215 can set the timeframe based on one or more events (e.g., the timeframe can be set to a duration of time extending from the last executed PI data retrieval operation to the currently scheduled PI data retrieval operation). Additionally, the scheduler 208 can generate multiple schedules 215, with respective schedules 215 associated with different production facilities 102, different controllers 200, different types of PI data metrics, and/or different PI servers 110.

The data collector 210 can retrieve PI data from the one or more PI servers 110 and/or production facilities 102 in accordance with the one or more schedules 215 and/or one or more databases 216. In one or more embodiments, the data collector 210 can monitor the one or more schedules 215 and can automatically retrieve the PI data in accordance with time, date, and/or time interval set by the one or more schedules 215. For instance, one or more PI data retrieval events set in the one or more schedules 215 can trigger the data collector 210 to automatically execute one or more PI data retrieval protocols, where the data collector 210 can authenticate and connect to the one or more PI servers 110 via the one or more networks 112. The one or more databases 216 can delineate controllers 200 associated with the PI data targeted for retrieval. In various embodiments, the data collector 210 can retrieve PI data associated with each controller 200 included on the database 216 associated with a given schedule 215 being implemented by the performance evaluator 104. For example, the data collector 210 can search the one or more PI databases 201 and retrieve IP data: associated with the one or more controllers 200 included in the database 216; and timestamped to the timeframe set by the schedule 215. In another example, the data collector 210 can retrieve IP data directly from the one or more controllers 200 included on the database 216 during the timeframe set by the schedule 215. In various embodiments, the database 216 can include detailed information of all included controllers 200, such as: name, source, location, functionality, equipment name, process functionality, and/or targeted performance set-points.

Additionally, the data analyzer 212 can analyze the PI data retrieved by the data collector 210 to generate one or more assessments, warnings, recommendations, and/or requests. In various embodiments, the data analyzer 212 can automatically execute a performance evaluation algorithm upon collection of the PI data. For example, the data analyzer 212 can, via the performance evaluation algorithm, compare one or more metric values included in the retrieved PI data with one or more predefined thresholds. Where the one or more metric values are compliant with the predefined thresholds, the data analyzer 212 can mark the metric values and associated PI data as characterizing satisfactory operations of the one or more production facilities 102. Where the one or more metric values a non-compliant with the predefined thresholds, the data analyzer 212 can mark the metric values and associated PI data as characterizing unsatisfactory operations of the one or more production facilities 102.

In another example, the data analyzer 212 can compare the one or more metric values included in the PI data with one or more metrics expected to be included. Where the PI data includes values for each of the expected metrics, the data analyzer 212 can determine that the PI data comprises a complete dataset for the associated controller 200. Where the PI data does not include values for one or more of the expected metrics, the data analyzer 212 can determine that the PI data incomplete for the associated controller 200.

In one or more embodiments, the data analyzer 212 can generate one or more warnings based on a metric value being absent and/or non-compliant with a predefined threshold. For example, the one or more warnings can define the amount of variation between the metric value of the PI data and the predefined threshold value. In some embodiments, the data analyzer 212 can generate one or more recommendations regarding adjustments to one or more settings of the controllers 200 that is predicted to result in compliant metric values in subsequent PI data retrievals and analyses. In one or more embodiments, the developed data analyzer 212 consists of six primary functions. A function named “Main,” can drive the execution of the written algorithm to achieve desired outcomes. A function named “ConntectToServer”, can establish a secure/authenticated connection with PI Server 110 through TCP/IP. A function named “RetreiveData” with given parameter named “ControllerName” of string data type, configured to retrieve given controller's 200 recorded events from established PI Server 110 connection based on specified timeframe. A function named “ExecludeBadData” with given parameter “RecordedEvents” of float array data type can be configured to execute a data cleansing analysis of retrieved recorded events to exclude predefined bad value indication (e.g., “bad”, “negative value”, “no data”). A function named “GetPerformanceRate” with given parameter “CleansedRecordedEvents” of float array data type can be configured to execute mathematical calculations of cleansed recorded events to generate controller's performance rate of specified timeframe. A function named “DataAnalytics” with given parameters “PerofrmanceRate”, “CleansedRecordedEvents” of type float and float array data type respectively can be configured to execute predefined analytical calculations to measure weighted performance rate based on cleansed recorded events and specified timeframe. This function aims to demonstrate/designate controller functional/systematical behavior, human intervention, performance sustainability/stability, and time duration of indicated low/undesired performance based on predefined performance set-point in database 216. A function named “Advisory” with “weightedPerformanceRate, ControllerLatestStatus” of float and String data type respectively. Developed to determine a predefined advisory statement/message to be generated driven by given weighted performance rate and controller latest defined status. This function aims to deliver a readable statement/message as an effective communication method to overall performance report audience.

In various embodiments, the publisher 214 can generate the one or more performance summary reports 106 based on the analysis of the data analyzer 212. For example, the one or more performance summary reports 106 can include the retrieved PI data in addition to: compliant versus non-compliant identifiers generated by the data analyzer 212; warnings generated by the data analyzer 212; and/or recommendations generated by the data analyzer 212. In various embodiments, the one or more performance summary reports 215 can include the PI data categorized according to the associated controller 200.

In some embodiments, the one or more performance summary reports 106 can further include a summary of the most recently retrieved PI data in comparison of past PI data. For example, the one or more performance summary reports 106 can include one or more metric values from the latest PI data retrieved by the data collector 210 along with metric values from historic PI data collections (e.g., previously retrieved by the data collector 210) in a chart and/or diagram. By presenting the latest metric values along with historic values, the one or more performance summary reports 106 can illustrate a pattern and/or trend in the PI data.

Additionally, the publisher 214 can automatically distribute access to, or a copy of, the one or more performance summary reports 106 amongst the one or more supervisor entities 108 upon completion of the performance summary reports 106. In one or more embodiments, the publisher 214 can automatically generate email correspondence addressed to one or more email accounts associated with the one or more supervisor entities 108, where the one or more performance summary reports 106 can be included and/or attached to the email correspondence. For instance, the email correspondence can include an HTML link to the one or more performance summary reports 106. For example, the publisher 214 can address the email to one or more email addresses set in the schedule 215 that triggered the automatic PI data retrieval and/or analysis characterized by the performance summary report 106.

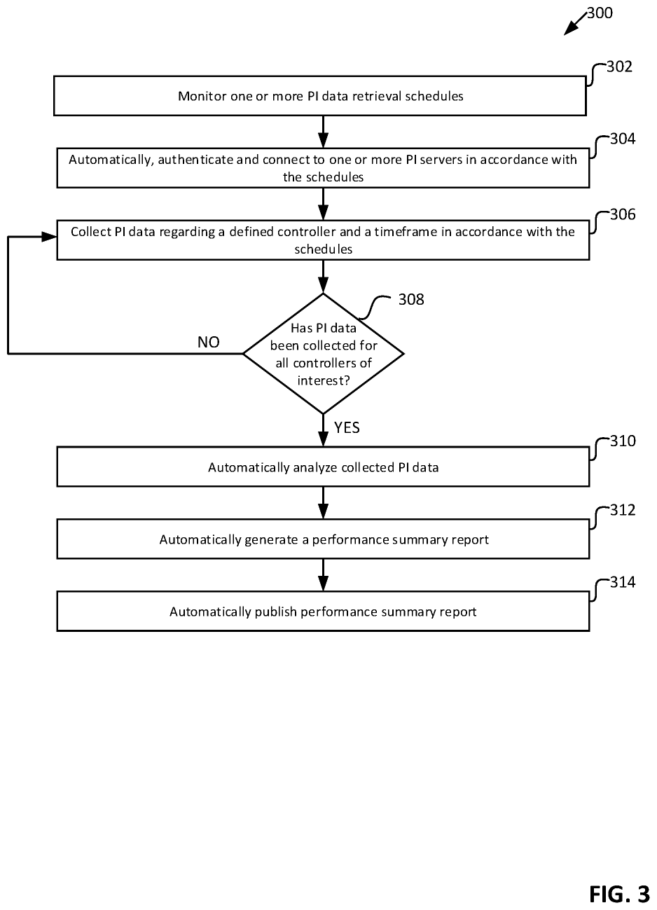

In view of the foregoing structural and functional features described above, example methods will be better appreciated with reference to FIG. 3. While, for purposes of simplicity of explanation, the example methods of FIG. 3 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

FIG. 3 illustrates a flow diagram of an example, non-limiting method 300 that can be implemented by the system 100 in accordance with one or more embodiments described herein. In various embodiments, the various features of method 300 can be performed automatically based on the occurrence of a scheduled event and/or the completion of a previous feature.

At 302, the method 300 can comprise monitoring (e.g., via data collector 210), by a system 100 operably coupled to one or more processing units 202, one or more PI data retrieval schedules 215. In accordance with one or more embodiments described herein, the one or more schedules 215 monitored at 302 can: define one or more PI data retrieval events, which can include dates and/or times to automatically initiate a PI data retrieval operation; identify one or more databases 216 that delineate controllers 200 of interest for the PI data retrieval; and/or one or more timeframes of interest for the PI data retrieval. In one or more embodiments, the one or more schedules 215 can be automatically generated (e.g., via scheduler 208) at the initialization of one or more controllers 200. In various embodiments, the one or more schedules 215 can be generated (e.g., via scheduler 208) based on one or more preferences of a user of the system 100 and/or a user associated with one or more of the supervisor entities 108.

At 304, the method 300 can comprise automatically authenticating and connecting (e.g., via data collector 210), by the system 100, to one or more PI servers 110 in accordance with the one or more schedules 215. For example, the authenticating and/or connecting at 304 can be automatically triggered by the identification (e.g. via the data collector 210) of an imminent PI data retrieval event on the one or more schedules 215. In various embodiments, the authenticating and connecting at 304 can be performed over the one or more networks 212 and can involve providing security credentials (e.g., username and/or password) to access one or more accounts associated with one or more of the PI servers 110.

At 306, the method 300 can comprise collecting (e.g., via data collector 210), by the system 100, PI data regarding one or more defined controllers 200 and defined timeframe in accordance with the one or more schedules 215. For example, in accordance with one or more embodiments described herein, the data collector 120 can search one or more PI databases 201 for PI data associated with the controllers 200 and timeframe defined in the schedule 215 monitored at 302.

In some embodiments, two or more controllers 200 can be identified on the databases 216 associated with a given schedule 215; where a first controller 200 can share PI data with a first PI server 110, and a second controller 200 can share PI data with a second PI server 110. For instance, the first controller 200 can be positioned in a first production facility 108 that stores PI data with the first PI server 108 and the second controller 200 can be positioned in a second production facility 108 that stores PI data with the second PI server 110. In another instance, the first controller 200 can be configured to measure and/or collect a first type of PI data (e.g., comprising a first type of performance metric), and the second controller 200 can be configured to measure and/or collect a second type of PI data (e.g., comprising a second type of performance metric); where the first PI server 110 stores the first type of PI data, and the second PI server 110 stores the second type of PI data. In either instance, the data collector 210 can authenticate and connect to both the first and second PI servers 110 at 304 to retrieve PI data regarding both controllers 200 of interest.

In some embodiments, two or more controllers 200 can be identified on the databases 216 associated with a given schedule 215; where a first controller 200 can be accessed via a first authentication account on a PI server 110, and the second controller 200 can be accessed via a second authentication account on the PI server 110. In such embodiments, the data collector 210 can establish a first connection with the PI server 110 using the authentication credentials associated with the first controller 200, retrieve the PI data associated with the first controller 200, and then establish a second connection with the PI server 110 using the authentication credentials associated with the second controller 200 to retrieve additional PI data associated with the second controller 200.

At 308, the method 300 can comprise determining (e.g., via data collector 210), by the system 100, whether PI data has been collected for all controllers 200 of interest (e.g., for all the controllers 200 defined in the given schedule 215. For example, the PI data collected from the one or more PI servers 110 can be labelled with an associated controller 200 (e.g., the source controller 200 for the PI data), and the schedule 215 monitored at 302 can be associated with a database 216 that defines controllers 200 of interest. At 308, the method 300 can comprise comparing the controllers 200 associated with the collected PI data with the controllers 200 of the database 216 to determine whether PI data has been collected from all the controllers 200 of interest. If PI data has not been collected for one or more controllers 200 identified in the schedule 215, the method 300 can repeat the PI data collection at 306 for the absent controllers 200. For instance, the data controller 210 can repeatedly search and/or retrieve PI data from the one or more PI servers 110 until PI data is collected for each controller 200 identified in the schedule 215. Once PI data for all of the controllers 200 of interest has been collected, the method 300 can proceed to 310.

At 310, the method 300 can comprise automatically analyzing (e.g., via data analyzer 212), by the system 100, the collected PI data. In accordance with one or more embodiments described herein, the data analyzer 212 compare the collected PI data with one or more defined threshold values associated with the respective metrics characterized by the PI data. Based on the comparison, the data analyzer 212 can generate one or more warnings and/or recommendations regarding compliant and/or non-compliant metric values (e.g., with respect to the predefined threshold values).

At 312, the method 300 can comprise automatically generating (e.g., via the publisher 214), by the system 100, one or more performance summary reports 106 that can include the collected PI data and/or one or more data analyses performed by the data analyzer 212. In accordance with various embodiments described herein, the one or more performance summary reports 106 can include one or more warnings and/or recommendations generated by the data analyzer 212. Additionally, at 314 the method 300 can comprise automatically publishing (e.g., via publisher 214), by the system 100, the one or more performance summary reports 106 to one or more supervisor entities 108.

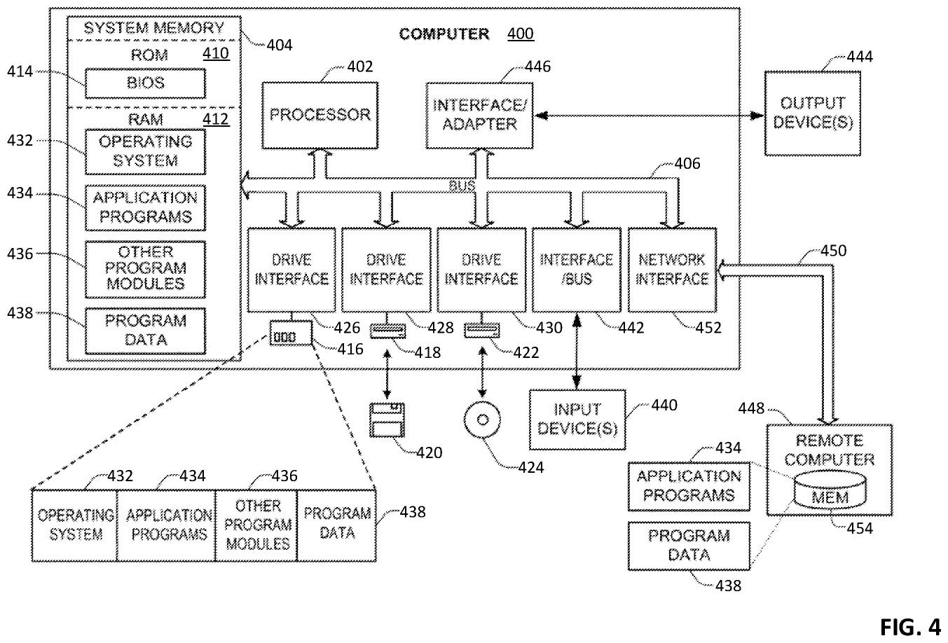

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 4. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 4 illustrates one example of a computer system 400 that can be employed to execute one or more embodiments of the present disclosure. Computer system 400 can be implemented on one or more general purpose networked computer systems, embedded computer systems, routers, switches, server devices, client devices, various intermediate devices/nodes or standalone computer systems. Additionally, computer system 400 can be implemented on various mobile clients such as, for example, a personal digital assistant (PDA), laptop computer, pager, and the like, provided it includes sufficient processing capabilities.

Computer system 400 includes processing unit 402, system memory 404, and system bus 406 that couples various system components, including the system memory 404, to processing unit 402. Dual microprocessors and other multi-processor architectures also can be used as processing unit 402. System bus 406 may be any of several types of bus structure including a memory bus or memory controller, a peripheral bus, and a local bus using any of a variety of bus architectures. System memory 404 includes read only memory (ROM) 410 and random access memory (RAM) 412. A basic input/output system (BIOS) 414 can reside in ROM 410 containing the basic routines that help to transfer information among elements within computer system 400.

Computer system 400 can include a hard disk drive 416, magnetic disk drive 418, e.g., to read from or write to removable disk 420, and an optical disk drive 422, e.g., for reading CD-ROM disk 424 or to read from or write to other optical media. Hard disk drive 416, magnetic disk drive 418, and optical disk drive 422 are connected to system bus 406 by a hard disk drive interface 426, a magnetic disk drive interface 428, and an optical drive interface 430, respectively. The drives and associated computer-readable media provide nonvolatile storage of data, data structures, and computer-executable instructions for computer system 400. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 410, including operating system 432, one or more application programs 434, other program modules 436, and program data 438. In some examples, the application programs 434 can include scheduler 208, data collector 210, data analyzer 212, publisher 214, and the program data 438 can include the one or more performance summary reports 106, schedules 215, and/or database 216. The application programs 434 and program data 438 can include functions and methods programmed to automatically collect and analyze PI data from one or more controllers 200 of one or more production facilities 102, such as shown and described herein.

A user may enter commands and information into computer system 400 through one or more input devices 440, such as a pointing device (e.g., a mouse, touch screen), keyboard, microphone, joystick, game pad, scanner, and the like. For instance, the user can employ input device 440 to edit or modify the one or more schedules 215, database 216, and/or predefined threshold values. These and other input devices 440 are often connected to processing unit 402 through a corresponding port interface 442 that is coupled to the system bus, but may be connected by other interfaces, such as a parallel port, serial port, or universal serial bus (USB). One or more output devices 444 (e.g., display, a monitor, printer, projector, or other type of displaying device) is also connected to system bus 406 via interface 446, such as a video adapter.

Computer system 400 may operate in a networked environment using logical connections to one or more remote computers, such as remote computer 448. Remote computer 448 may be a workstation, computer system, router, peer device, or other common network node, and typically includes many or all the elements described relative to computer system 400. The logical connections, schematically indicated at 450, can include a local area network (LAN) and a wide area network (WAN). When used in a LAN networking environment, computer system 400 can be connected to the local network through a network interface or adapter 452. When used in a WAN networking environment, computer system 400 can include a modem, or can be connected to a communications server on the LAN. The modem, which may be internal or external, can be connected to system bus 406 via an appropriate port interface. In a networked environment, application programs 434 or program data 438 depicted relative to computer system 400, or portions thereof, may be stored in a remote memory storage device 454.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such. While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method, comprising:
establishing an authenticated connection with a performance indicator server in accordance with a defined schedule, wherein the performance indicator server stores data from one or more controllers that manage assets of a production facility; and
automatically evaluating a performance of the production facility, via a performance evaluation algorithm, in response to collecting performance indicator data via the authenticated connection.

2. The method of claim 1, further comprising:
monitoring the defined schedule, wherein the defined schedule delineates when and how often the authenticated connection is to be established, wherein the defined schedule further delineates a timeframe associated with the performance indicator to be collected, and wherein the defined schedule is associated with a controller list.

3. The method of claim 2, wherein the defined schedule delineates establishing the authenticated connection once every twenty-four hours.

4. The method of claim 2, further comprising:
collecting the performance indicator data for the one or more controllers, wherein the one or more controllers are included in the controller list.

5. The method of claim 4, wherein the evaluating the performance of the production facility comprises comparing metric values of the performance indicator data to threshold values that characterize compliant performance of the production facility.

6. The method of claim 5, further comprising:
generating a performance summary report that includes the performance indicator data and characterizes the comparing of the metric values to the threshold values.

7. The method of claim 6, further comprising:
automatically distributing access to the performance summary report to one or more supervisor entities via an electronic correspondence upon generation of the performance summary report, wherein the one or more supervisor entities are associated with the one or more controllers.

8. The method of claim 6, further comprising:
automatically distributing a copy of the performance summary report to one or more supervisor entities via an electronic correspondence upon generation of the performance summary report, wherein the one or more supervisor entities are associated with the one or more controllers.

9. A system, comprising:
memory to store computer executable instructions; and
one or more processors, operatively coupled to the memory, that execute the computer executable instructions to implement:
a data collector configured to establish an authenticated connection with a performance indicator server in accordance with a defined schedule, wherein the performance indicator server stores data from one or more controllers that manage assets of a production facility; and
a data analyzer configured to automatically evaluate a performance of the production facility, via a performance evaluation algorithm, in response to collecting performance indicator data via the authenticated connection.

10. The system of claim 9, wherein the defined schedule delineates when and how often the authenticated connection is to be established, wherein the defined schedule further delineates a timeframe associated with the performance indicator to be collected, and wherein the defined schedule is associated with a controller list.

11. The system of claim 10, wherein the defined schedule delineates establishing the authenticated connection once every twenty-four hours.

12. The system of claim 10, wherein the data collector is configured to collect the performance indicator data for the one or more controllers, wherein the one or more controllers are included in the controller list.

13. The system of claim 12, wherein the data analyzer is configured to compare metric values of the performance indicator data to threshold values that characterize compliant performance of the production facility.

14. The system of claim 13, further comprising:
a scheduler configured to generate a performance summary report that includes the performance indicator data and characterizes the comparing of the metric values to the threshold values.

15. The system of claim 14, further comprising:
a publisher configured to automatically distribute access to the performance summary report to one or more supervisor entities via an electronic correspondence upon generation of the performance summary report, wherein the one or more supervisor entities are associated with the one or more controllers.
